(19) United States
(12) Patent Application Publication
(10) Pub. No.: US 2009/0027214 A1
(43) Pub. Date: Jan. 29, 2009

(54) Fuel filter monitor

(76) Inventor: Robert M. Elwood, Sebastian, FL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/216,991

(22) Filed: Jul. 14, 2008

Related U.S. Application Data
(60) Provisional application No. 60/935,018, filed on Jul. 23, 2007.

(51) Int. Cl. G08B 21/00

(52) U.S. Cl. 340/607

(57) ABSTRACT

The fuel filter monitor measures pressure upstream and downstream of a fuel filter or filter bank. A solid state differential pressure sensor senses the pressure difference across the filter or filter bank. The analog output of the pressure sensor is connected to an electronic gauge for continuous monitoring of the pressure differential to determine if the filter is reaching clogged condition. The analog output signal can be supplied to an analog to digital converter and the digital information supplied to a processor for pressure trending.

### CROSS-REFERENCE TO RELATED APPLICATION

This application claims the benefit of U.S. Provisional Patent Application Ser. No. 60/935,018, filed Jul. 23, 2007.

### BACKGROUND OF THE INVENTION

1. Field of the Invention

The present invention relates to filter monitoring apparatus. More particularly, the present invention relates to a fuel filter monitor for monitoring the differential pressure across a fuel filter or a fuel filter bank in a diesel engine.

2. Description of the Related Art

Diesel engines, such as engines used in boats and trucks, use fuel filters to ensure that fuel reaching the combustion chambers from the fuel tanks is clean. Fuel filters clog over a period of time from accumulation of particles filtered from the fuel. A clogged fuel filter degrades engine performance, and when the filter becomes sufficiently clogged, the engine will fail to operate. It is desirable to change fuel filters before the filter prevents operation of the engine, and to keep the engine running at peak efficiency. A fuel filter monitor to continuously monitor the condition of the fuel filter or filters is therefore desirable.

Filter indicators are usually electrical or visual devices calibrated for a preset or predetermined pressure setting. Once the setting has been exceeded the indicator provides a warning to the user. Devices used to measure fuel pressure in an engine at a single point or differentially at multiple points in the fuel system generally use a gauge with a movable diaphragm connected to vacuum hoses, or a coiled tube connected to a gauge arm by a gear train, the tube uncoiling in response to pressure changes, e.g., a Bourdon gauge. In many applications, running vacuum hose the required distances between the filter and gauge, such as on a boat where the bridge may be far removed from the fuel lines, is not practical with such a mechanical gauge.

Thus, a fuel filter monitor solving the aforementioned problems is desired.

### SUMMARY OF THE INVENTION

The fuel filter monitor measures pressure upstream and downstream of a fuel filter or filter bank. A differential pressure sensor senses the pressure difference across the filter or filter bank. The analog output of the pressure sensor is connected to an electronic gauge for continuous monitoring of the pressure differential to determine if the filter is reaching clogged condition. The analog output signal can be supplied to an analog to digital converter and the digital information supplied to a processor for pressure trending.

The significance of monitoring differential pressure using a solid state sensor as opposed to a mechanical differential vacuum gauge is the ease of installation. With the fuel filter monitor, only a small gauge set of wires needs to be run between the sensor and the gauge, and vacuum hoses.

These and other features of the present invention will become readily apparent upon further review of the following specification and drawings.

### BRIEF DESCRIPTION OF THE DRAWINGS

FIG. 1 is block diagram of a first embodiment of a fuel filter monitor according to the present invention using an electronic gauge to continuously display differential pressure.

FIG. 2 is a block diagram of a second embodiment of a fuel filter monitor according to the present invention using an analog to digital converter and a processor.

Similar reference characters denote corresponding features consistently throughout the attached drawings.

### DETAILED DESCRIPTION OF THE PREFERRED EMBODIMENTS

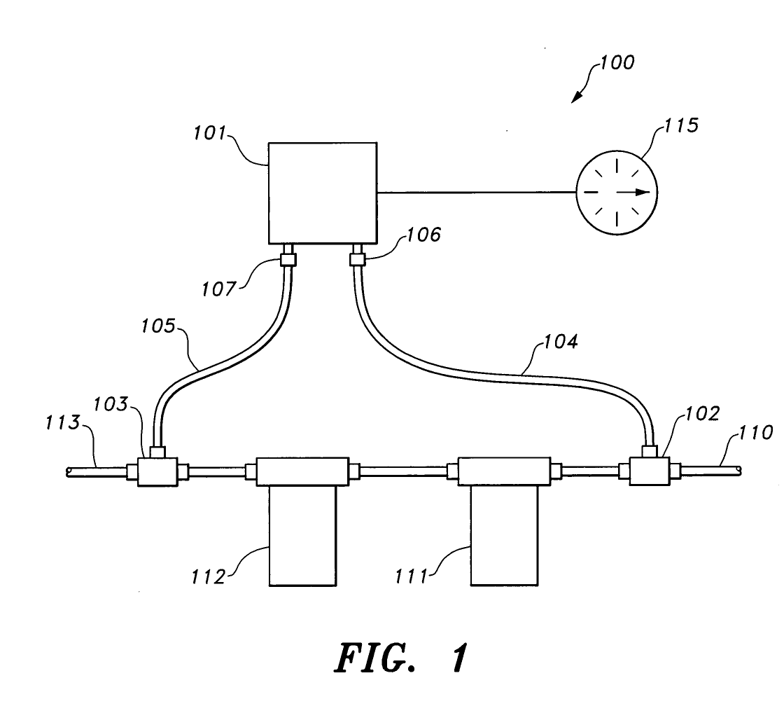

The present invention relates to a diesel fuel filter condition monitor 100. As shown in FIG. 1, a fuel line tee with valve and quick connect fitting assembly 102 is connected to the upstream portion 110 of the fuel line. Another fuel line tee with valve and quick connect fitting assembly 103 is connected to the fuel line 113 downstream from the filters 111 and 112. A first vacuum hose 104 is connected to the assembly 102 at one end and connected to high vacuum port 106 of differential pressure sensor 101 at the other end. Differential pressure sensor 101 may be a solid state piezoresistive silicon type or any other type of differential pressure sensor that provides an output that can be translated into differential pressure readings (analog or digital). Exemplary differential pressure sensors types (without limitation) that may be used in the fuel filter monitor include capacitive sensors, bonded strain gauge sensors, bonded foil gauge sensors, and the like.

A second vacuum hose 105 is connected to assembly 103 at one end and connected to low vacuum port 107 of differential pressure sensor 101 at the other end. Exemplary material composition (without limitation) of hoses 104 and 105 are nylon, rubber, fire rated rubber, copper tubing, and the like. The sensor produces an analog signal indicative of the differential pressure across the filters. The analog signal is sent to an electronic gauge 115 to provide a continuous reading of the differential pressure across the filters 111 and 112.

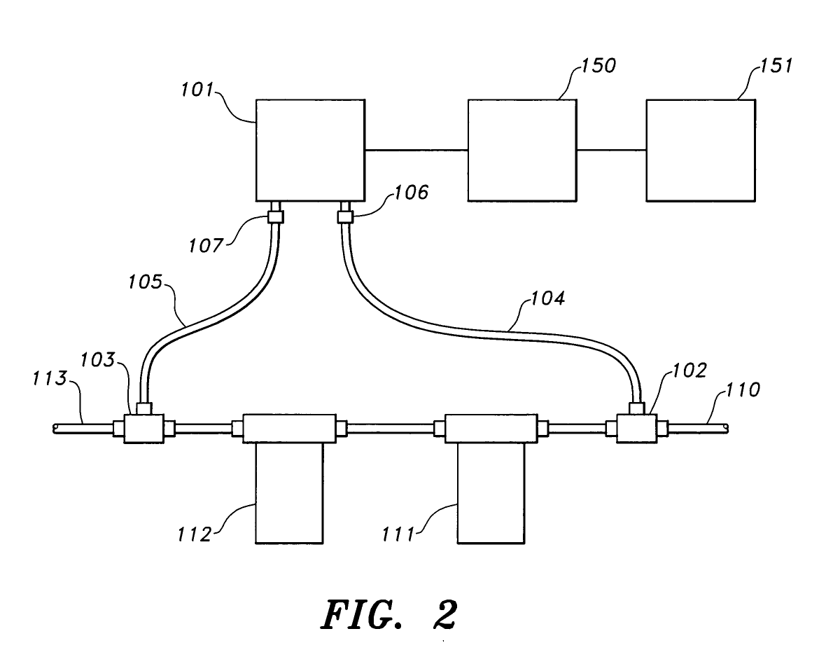

In FIG. 2, the analog signal from differential pressure sensor 101 is sent to an analog to digital converter 150. The digital output of the converter is sent to a microprocessor 151 for pressure trending and setting alarms when the rate of change in vacuum differential exceeds previously recorded data.

When the fuel filters are new, the differential pressure will be indicated on the electronic gauge as a certain level, and when the filters become clogged, the pressure differential between the engine side of the filter and the tank side will indicate a significant increase in the pressure differential alerting the operator of a filter clogging condition.

Load conditions of the engine being monitored will have an effect on the vacuum indicated. However, when the trend under load condition is monitored, it will indicate the relative condition of the fuel filters.

It is to be understood that the present invention is not limited to the embodiments described above, but encompasses any and all embodiments within the scope of the following claims.

I claim:

1. A fuel filter monitor, comprising:
a first fuel line tee having a valve and quick connect fitting assembly adapted for connection to the fuel line upstream from a filter being monitored;
a second fuel line tee having valve and quick connect fitting assembly adapted for connection to the fuel line downstream from a filter being monitored;
a first vacuum hose connected to the first fuel line tee;
a second vacuum hose connected to the second fuel line tee;
a solid state differential pressure sensor having a low vacuum port connected to the second vacuum hose and a high vacuum port connected to the first vacuum hose, respectively, the differential pressure sensor having an analog output signal representative of the difference in pressure between the low vacuum port and the high vacuum port; and
an electronic gauge receiving the analog signal and providing a continuous reading of the pressure differential across the filter.

2. The fuel filter monitor according to claim 1, wherein said vacuum hoses are formed of nylon.

3. The fuel filter monitor according to claim 1, wherein said vacuum hoses are formed of metallic tubing.

4. The fuel filter monitor according to claim 3, wherein said metallic tubing is copper.

5. The fuel filter monitor according to claim 1, wherein said vacuum hoses are formed of rubber.

6. The fuel filter monitor according to claim 5, wherein said rubber vacuum hoses are fire-rated.

7. The fuel filter monitor according to claim 1, further comprising:
an analog-to-digital converter receiving the analog signal from the differential pressure sensor; and
a microprocessor receiving a digital signal from the analog-to-digital converter, the microprocessor recording and processing the digital signal and providing pressure trending and alarms when the rate of change in vacuum differential exceeds previously recorded data.

8. The fuel filter monitor according to claim 1, wherein the electronic gauge further comprises an alarm indicator, the alarm indicator indicating an excessive pressure differential between the upstream and downstream pressure monitoring locations, thereby notifying a user that the filter has become clogged.
